(19) United States
(12) Patent Application Publication
(10) Pub. No.: US 2018/0022897 A1
(43) Pub. Date: Jan. 25, 2018

(54) Insulating Tapes For A Coil And Wrapping Tape Insulation Systems For Electric Machines

(71) Applicant: SIEMENS AKTIENGESELLSCHAFT, Muenchen (DE)

(72) Inventors: Juergen HUBER, Erlangen (DE); Dieter SCHIRM, Breitenguessbach (DE); Matthias UEBLER, Ursensollen (DE)

(73) Assignee: Siemens Aktiengesellschaft, Muenchen (DE)

(21) Appl. No.: 15/548,319

(22) PCT Filed: Jan. 19, 2016
(86) PCT No.: PCT/EP2016/050958

§ 371 Date: Aug. 2, 2017

(30) Foreign Application Priority Data
Feb. 5, 2015 (DE) 10 2015 202 053.3
May 7, 2015 (DE) 10 2015 208 527.9
Aug. 4, 2015 (DE) 10 2015 214 872.6

(51) Int. Cl. C08K 5/3445; H01B 3/40; C08J 3/20; H02K 3/30; C08J 3/075

(52) U.S. Cl. CPC C08K 5/3445; H02K 3/30; C08J 3/075; C08J 3/203; H01B 3/40; H02K 3/40

(57) ABSTRACT

An insulating tape having a tape adhesive comprising at least one tape accelerator. The tape accelerator may be comprised of an imidazole, an imidazole derivative, a pyrazole, a pyrazole derivative, and combinations thereof. The tape is particularly useful for insulation for stator coils of electrical machines.

### CROSS-REFERENCE TO RELATED APPLICATIONS

This application is a U.S. National Stage Application of International Application No. PCT/EP2016/050958 filed Jan. 19, 2016, which designates the United States of America, and claims priority to DE Application No. 10 2015 202 053.3 filed Feb. 5, 2015, DE Application No. 10 2015 208 527.9 filed May 7, 2015, and DE Application No. 10 2015 214 872.6 filed Aug. 4, 2015, the contents of which are hereby incorporated by reference in their entirety.

### FIELD OF THE INVENTION

The invention relates to an insulating tape for insulating stator coils in electrical machines, especially the tape accelerator in the tape adhesive of the insulating tape which is used for a wrapping tape insulating system.

### BACKGROUND OF THE INVENTION

With electrical machines, the stator and in certain cases the rotor as well, have insulating systems featuring windings. In such arrangements, an insulating tape is wrapped around a conductor or a bundle of conductors.

The insulating tape comprises a sheet-like, breakdown-resistant, inorganic material, such as mica platelets and/or fine mica layers, which is applied on a flexible backing such as foil or glass fabric, and which is joined to the backing and to one another and, optionally, to a concluding outer ply and/or a further ply, by means of a tape adhesive.

This tape adhesive comprises a tape accelerator ultrafinely divided and/or dissolved therein. The purpose of the tape accelerator is to gel a highly mobile impregnating resin which is applied to the stator windings in a vacuum pressure impregnation (VPI) procedure, for example. After the gelling at elevated temperature, the impregnated stator windings are cured thermally in the laminated core of the stator.

One such insulating tape is known from DE 38 24 254 A1. EP 0424376 B1 discloses corresponding tape adhesives and tape accelerators.

The tape adhesives disclosed therein are the 1:4-molar adducts of bisphenols, especially bisphenol A, and cycloaliphatic epoxy resins, especially 3,4-epoxycyclohexylmethyl 3,4-epoxycyclohexanecarboxylate.

This binder, in its theoretical molecular structure after quantitative conversion, presumably contains almost exclusively cycloaliphatic oxirane functionalities in addition to the hydroxyl groups likewise created through the addition reaction. It is further disclosed in EP 0424376 B1 that the associated tape accelerator is preferably a 1:3-molar adduct of trimethylolpropane triacrylate and N-ethylpiperazine.

The tape accelerator and/or the tape adhesive in the mica tape assembly are preferably equipped chemically such that there is no premature, unwanted curing during storage below room temperature. This ensures processability of the mica tape. Following impregnation of the stator coils containing tape adhesive, the gelling of the glycidyl ether-based epoxy resin takes place very rapidly, since terminal oxirane functionalities in interaction with acyl anhydrides are subject to very rapid polymerization. Phthalic anhydride and anhydrides are toxic.

### SUMMARY OF THE INVENTION

It is an object of the present invention, therefore, to provide an insulating tape and in particular a tape accelerator for insulating tape that can be used in anhydride-free VPI resins. A further object of the invention is to provide an insulating system, a coil, and an electrical machine having an insulating tape that is impregnated with an anhydride-free resin.

The present invention provides an insulating tape having a tape adhesive in which there is at least one tape accelerator in solution and/or in ultrafine divided form, wherein the at least one tape accelerator is an imidazole and/or a pyrazole and/or a derivative of an imidazole and/or a derivative of a pyrazole.

A derivative presently refers to a chemical derivative, in other words a derived substance or a derived compound which may be produced from the parent compound—for example, imidazole and/or pyrazole—by, e.g., substitution of one or more hydrogen atoms. This substitution may take place in many different chemical ways.

### DETAILED DESCRIPTION OF THE PREFERRED EMBODIMENTS OF THE INVENTION

The present invention provides an insulating tape having a tape adhesive in which there is a tape accelerator in solution and/or in ultrafine divided form, said accelerator being an adduct of at least one imidazole and/or at least one pyrazole with at least one acrylate and/or being an adduct of one or more imidazole derivatives and/or of one or more pyrazole derivatives with one or more acrylate derivatives. Any desired combinations of derivatives and parent compounds may form the adduct. The adduct itself is likewise a product of derivatization, and thus itself is also a derivative.

According to one further embodiment, the heterocycle is a 1H-nitrogen heterocycle having 1 to 4 nitrogen atoms in the ring that preferably melts at relatively low temperatures and/or is liquid at room temperature.

Employed more preferably is a singly substituted alkyl-/acyl-imidazole. It is possible for example to use imidazoles such as 1H-2-methylimidazole (CAS No. 693-98-1) or 1H-imidazole (CAS No. 288-32-4), 1H-2-ethylimidazole (CAS No. 1072-62-4), 1H-2-propylimidazole (CAS No. 50995-95-4), 1H-2-isopropylimidazole (CAS No. 36947-68-9), 1H-2-butylimidazole (CAS No. 50790-93-7), 1H-2-isobutylimidazole (CAS No. 61491-92-7), 1H-2-tert-butylimidazole (CAS No. 36947-69-0), 1H-4-tert-butylimidazole (CAS No. 21149-98-4), 1H-4(5)-methylimidazole (CAS No. 822-36-6), 1H-2-ethyl-4-methylimidazole (CAS No. 931-36-2), 1H-4-methyl-2-phenylimidazole (CAS No. 827-43-0), 1H-4-phenylimidazole (CAS No. 670-95-1), 1H-5-methyl-2-phenylimidazole-4-methanol (CAS No. 13682-32-1), 1H-2-phenylimidazole (CAS No. 670-96-2), 1H-3-phenylpyrazole (CAS No. 2458-26-6), 1H-5-methylpyrazole (no CAS No.), 1H-3,4-dimethylpyrazole (CAS No. 2820-37-3), 1H-3-tert-butylpyrazole (CAS No. 15802-80-9), 1H-4-ethylpyrazole (CAS No. 17072-38-7), but also 1H-pyrazole (CAS No. 288-3-1) and/or 1H-3,5-dimethylpyrazole (CAS No. 67-51-6).

According to the prior art, especially the phthalic anhydride-containing impregnating resins of the kind known from EP 0424376 B1, tape adhesives disclosed are the 1:4-molar adducts of bisphenols, especially of bisphenol A, and cycloaliphatic epoxy resins, especially of 3,4-epoxycyclohexylmethyl 3,4-epoxycyclohexanecarboxylate. In its theoretical molecular structure, the tape adhesive described therein, after quantitative conversion, contains only cycloaliphatic oxirane functionalities, in addition to the hydroxyl groups likewise created by the addition reaction. It is further read from the aforesaid patent specification that the associated tape accelerator is preferably a 1:3-molar adduct of trimethylolpropane triacrylate and N-ethylpiperazine. As a result of the underlying aza-Michael reaction, accordingly, the adduct contains theoretically three terminal piperazine nitrogen atoms with tertiary substitution.

Thus, for example, a phthalic anhydride-free and, moreover, binder-free bisphenol F diglycidyl ether, which is gelled with 3 wt % of the piperazine tape accelerator and is cured by anionic polymerization at 145° C. for ten hours, produces only a glass transition of around 90° C., whereas the phthalic anhydride-containing Micalastic resin with binder and tape accelerator that has been employed as the standard to date develops a glass transition of around 160° C. on identical curing.

If use is made in contrast, for example, of 2 wt % of 1,2-dimethylimidazole as gelling and curing accelerator for a phthalic anhydride-free, epoxy resin-based impregnating resin, such as distilled bisphenol F diglycidyl ether, for example, then a glass transition of 134° C. is established in the presence of binder, and a glass transition even of 150° C. in the absence of binder. This shows the superiority of the imidazoles as gelling and curing catalysts for phthalic anhydride-free epoxy resins, in contrast to the N-alkyl-substituted piperazine derivatives of trimethylolpropane triacrylate.

In comparison to EP 0424376 B1, in other words to the 1:3-molar adduct of trimethylolpropane triacrylate (“TMPTA”) and N-ethylpiperazine, the adducts presented here for the first time in the art as tape accelerators, namely the adducts of triacrylates, but especially also of the tetra- and penta-/hexa-acrylates, with 1H-2-methylimidazole, 1H-2-ethylimidazole, 1H-2-propylimidazole, 1H-2-isopropylimidazole, 1H-2-butylimidazole, 1H-2-isobutylimidazole, 1H-2-phenylimidazole, and 1H-2-ethyl-4-methylimidazole, are compounds of particular interest as tape accelerators, because
a) the glass transition temperatures achievable by anionic polymerization with phthalic anhydride-free, diglycidyl ether-based impregnating resins are much higher than when using the N-methylpiperazine and N-ethylpiperazine adducts of TMPTA;
b) nonacidic alkyl-/acylimidazoles gel and cure phthalic anhydride-free impregnating resins with lower contents than an N-alkylpiperazine-TMPTA adduct (alkyl=methyl, ethyl);
c) the adduct of 1H-2-methylimidazole, 1H-2-ethylimidazole, 1H-2-isopropylimidazole, 1H-2-propylimidazole, and 1H-2-ethyl-4-methylimidazole with TMPTA is more favorable in terms of raw materials prices than the adduct of TMPTA with N-ethylpiperazine.

1-Methyl-2-alkylimidazoles per se are not vacuum-stable and even at room temperature are highly mobile liquids; as a result, they may very easily migrate under reduced pressure at elevated temperature, during the evacuating and preliminary drying phases of the stators to be impregnated, from the insulating tape adhesive. The imidazoles derivatized with acrylates are therefore a preferred exemplary embodiment of the invention.

As a result of the covalent attachment of the 1H-2-alkylimidazoles at the 1H position, especially of 1H-2-methylimidazole, 1H-2-ethylimidazole, 1H-2-propylimidazole, 1H-isopropylimidazole, 1H-2-ethyl-4-methylimidazole, 1H-2-butylimidazole, 1H-2-isobutylimidazole, and 1H-2-tert-butylimidazole, to the TMPTA used hitherto, via an aza-Michael coupling, for example, it is possible to substitute the N-ethylpiperazine derivative of TMPTA, which is unsuitable for phthalic anhydride-free epoxy resins, by an alkylimidazole-TMPTA variant which is now suitable for this class of impregnating resin. In numerous experiments it has been discovered that, for example, 1,2-dimethylimidazole at 2 wt %, based on the phthalic anhydride-free epoxy resin, yields high glass transitions of up to 150° C. in otherwise identical curing scenarios.

Conversely, the N-ethylpiperazine-containing tape accelerator produces only around 90° C. as a glass transition in phthalic anhydride-free glycidyl ether epoxy resins. Because of the high vapor pressure of the 2-alkylimidazoles and the high fluidity, however, the dispersing of small imidazole molecules and/or imidazole derivatives in the tape adhesive is associated with a subsequent risk that the evacuating phase (70° C., 0.1 mbar for up to 72 hours) will cause evaporation and/or migration of the volatile alkylimidazole, which will accumulate at relatively cold sites.

This is counteracted by derivatization with acrylate, in other words by the covalent attachment of the 1H-alkylimidazoles to an acrylate, such as the TMPTA molecule, for example. This is accompanied by a drastic increase in viscosity as a result of the construction of a tape accelerator molecule. In this way, migration from the tape adhesive is effectively retarded.

The adducts of 1H-2-methylimidazole, 1H-2-ethylimidazole, 1H-2-propylimidazole, 1H-2-isopropylimidazole, and 1H-2-butylimidazole, and/or branched 1H-2-isobutylimidazole and 1H-2-tert-butylimidazole, with acrylates, in particular, result in a cost saving in the end structure and also in an increase in the network density as a result of the structure-dependent number of polymerization initiators when using higher acrylates such as PETA and DPHA.

A comparison with the piperizine-containing accelerator as known from the prior art is shown here once again in table form. The first line contains the reference sample with the accelerator according to EP 0424376 B1.

TABLE 1

| | | | Total | | |
|---|---|---|---|---|---|
| | Vinyl | N- | molar | | Raw |
| | com- | Hetero- | mass | Nitrogen | materials |
| Tape accelerator | ponent | cycle | [g/mol] | centers* | costs [%] |
| [Prior art] | TMPTA | N-ethyl- | 638.89 | 3 | 100 |
| TMPTA-(N- | | piperazine | | | |
| ethyl- | | | | | |
| piperazine)₃ | | | | | |
| TMPTA- | TMPTA | imidazole | 500.56 | 3 | 92 |
| (imidazole)₃ | | | | | |
| TMPTA-(2- | TMPTA | 2-methyl- | 542.62 | 3 | 71 |
| methyl- | | imidazole | | | |
| imidazole)₃ | | | | | |
| TMPTA-(2-ethyl | TMPTA | 2-ethyl- | 584.71 | 3 | 71 |
| imidazole)₃ | | imidazole | | | |
| PETA- | PETA | imidazole | 624.66 | 4 | 104 |
| (imidazole)₄ | | | | | |
| PETA-(2-methyl- | PETA | 2-methyl- | 680.74 | 4 | 80 |
| imidazole)₄ | | imidazole | | | |
| PETA-(2-ethyl- | PETA | 2-ethyl- | 736.86 | 4 | 80 |
| imidazole)₄ | | imidazole | | | |
| DPHA- | DPHA | imidazole | 898.95 | 5.5 | 89 |
| (imidazole)_{5.5} | | | | | |
| DPHA-(2-methyl- | DPHA | 2-methyl- | 976.06 | 5.5 | 67 |
| imidazole)_{5.5} | | imidazole | | | |
| DPHA-(2-ethyl- | DPHA | 2-ethyl- | 1053.23 | 5.5 | 68 |
| imidazole)_{5.5} | | imidazole | | | |

*the centers available for initiation of polymerization

In relation to the conventional VPI impregnating operation, the vapor pressures of the alkylimidazoles at elevated temperatures are somewhat disadvantageous; in particular, the vapor pressure of the advantageous 1-alkyl-2-methylimidazoles is relatively high, and so, during long-lasting evacuation phases at elevated temperatures, of the kind nowadays sometimes employed—for preliminary drying, for instance—in the production of electrical machines, prior to the VPI impregnation of the stators, there is a risk of partial expulsion from the tape adhesive of any imidazoles used.

In the case of other impregnating processes, however, the alkylimidazoles—that is, generally, the smaller imidazole derivatives which are therefore in general volatile at elevated temperatures—have proven to be highly efficient tape accelerators.

With an exemplary embodiment of the invention, a tape accelerator which is an adduct of a 1H-imidazole derivative and/or of a 1H-pyrazole derivative with an acrylate, success is achieved in providing a tape accelerator in binder-containing mica papers that can be modified in such a way that it is vacuum-stable at temperatures of 50-80° C. For example, a tape adhesive of this kind exhibits a vapor pressure of less than 10⁻⁴ mbar at 70° C., and also a high dynamic viscosity.

For this purpose, the 1H-alkylimidazoles and/or the 1H-alkylpyrazoles are derivatized, for example, with acrylates.

According to one embodiment, the acrylate is an acrylate which is liquid at room temperature, such as, for example, trimethylolpropane triacrylate (TMPTA, CAS No. 15625-89-5); trimethylolpropane propoxylate triacrylate (no synonym, CAS No. 53879-54-2);

pentaerythritol tetraacrylate (PETA, CAS No. 4986-89-4), and/or dipentaerythritol pentacrylate/dipentaerythritol hexacrylate (technical DPHA mixture, CAS No. 60506-81-2).

Below, examples of exemplary embodiments of the derivatives are shown in structural formulae.

The following adducts are exemplary embodiments of a tape accelerator according to the invention:

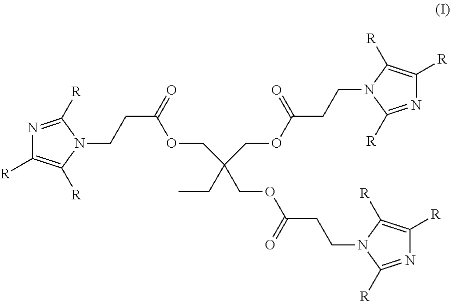

The structural formula I shown here represents an exemplary embodiment of a tape accelerator according to the invention, and is a possible adduct of TMPTA and one or more 1H-imidazole derivatives; for example, with R identical or different and

R may be H, methyl, ethyl, n-propyl, isopropyl, n-butyl, isobutyl, tert-butyl, phenyl and/or mono-, di-, tri-, tetra-, penta-substituted phenyl, it being possible for the substituents on the phenyl radical again to be identical or non-identical and to be selected from the following group: R_{phenyl} is alkyl (linear and branched), alkoxy, F, Cl, Br, I, aldehyde, ketone, acyl ester, acyl amide, phosphonic acid derivative and/or sulfonic acid derivative.

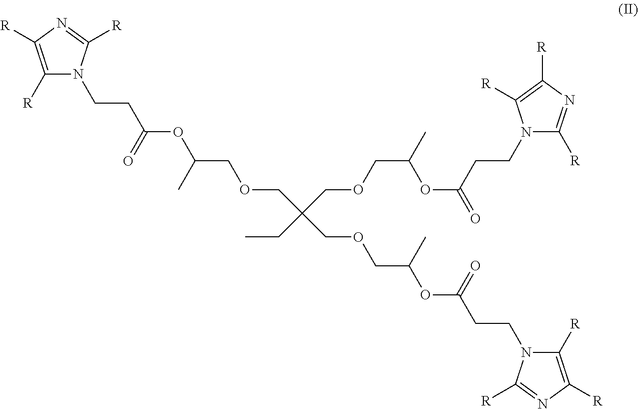

The structural formula II shown above represents a further exemplary embodiment of a tape accelerator according to the invention, and is a possible adduct of trimethylolpropane propoxylate triacrylate and 1H-imidazole derivatives; for example, with R identical or non-identical and

R may be H, methyl, ethyl, n-propyl, isopropyl, n-butyl, isobutyl, tert-butyl, phenyl and/or mono-, di-, tri-, tetra-, penta-substituted phenyl, it being possible for the substituents on the phenyl radical again to be identical or non-identical and to be selected from the following group: R_{phenyl} is alkyl (linear and branched), alkoxy, F, Cl, Br, I, aldehyde, ketone, acyl ester, acyl amide, phosphonic acid derivative and/or sulfonic acid derivative.

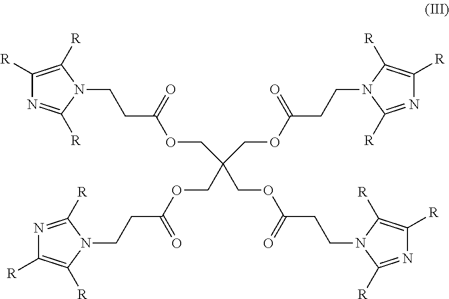

The structural formula III shown here represents yet another exemplary embodiment of a tape accelerator according to the invention, and is a possible adduct of pentaerythritol tetraacrylate (PETA) and 1H-imidazole derivatives; for example, with R identical or non-identical and

R may be H, methyl, ethyl, n-propyl, isopropyl, n-butyl, isobutyl, tert-butyl, phenyl and/or mono-, di-, tri-, tetra-, penta-substituted phenyl, it being possible for the substituents on the phenyl radical again to be identical or non-identical and to be selected from the following group: R_{phenyl} is alkyl (linear and branched), alkoxy, F, Cl, Br, I, aldehyde, ketone, acyl ester, acyl amide, phosphonic acid derivative and/or sulfonic acid derivative.

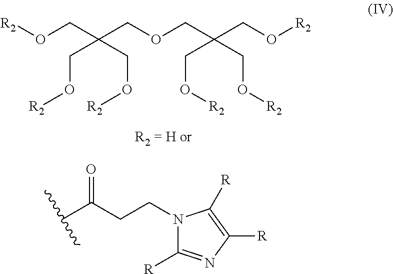

The structural formula IV shown here represents yet another exemplary embodiment of a tape accelerator according to the invention, and is a possible adduct of dipentaerythritol penta-/hexacrylate (DPHA) and 1H-imidazole derivatives; for example, with R identical or non-identical and

R may be H, methyl, ethyl, n-propyl, isopropyl, n-butyl, isobutyl, tert-butyl, phenyl and/or mono-, di-, tri-, tetra-, pentasubstituted phenyl, it being possible for the substituents on the phenyl radical again to be identical or non-identical and to be selected from the following group: R_{phenyl} is alkyl (linear and branched), alkoxy, F, Cl, Br, I, aldehyde, ketone, acyl ester, acyl amide, phosphonic acid derivative and/or sulfonic acid derivative

and R₂ as indicated above.

Here it has been possible to show that imidazoles and/or pyrazoles are very effective gelling and curing substances for phthalic acid-free epoxy resins based on bisphenol A and/or bisphenol F diglycidyl ether.

Suitable tape adhesives are available commercially and are based for example on silicone elastomer.

The invention relates to an insulating tape for insulating stator coils in electrical machines, especially the tape accelerator in the tape adhesive of the insulating tape. The N-ethylpiperazine-based tape accelerators known to date are replaced here by new and better compounds. The invention further relates to the use of an imidazole and/or of a pyrazole and/or of an imidazole derivative and/or pyrazole derivative as gelling and/or curing substance for phthalic acid-free epoxy resins based on bisphenol A and/or bisphenol F diglycidyl ether.

The invention relates to an insulating tape for insulating stator coils in electrical machines, especially the tape accelerator in the tape adhesive of the insulating tape, which is used for a wrapping tape insulating system. The N-ethylpiperazine-based tape accelerators known to date are replaced here by imidazole and/or pyrazole compounds. Through further exemplary embodiments of the invention, moreover, there is an expansion of the use of the imidazole and/or pyrazole compounds newly found for this technology, as gelling and/or curing agents generally in epoxy resins based on bisphenol A and/or bisphenol F diglycidyl ether, especially the phthalic acid-free species thereof.

What is claimed is:

1-9. (canceled)

10. An insulating tape comprising a tape adhesive including at least one tape accelerator in solution and/or in ultrafine divided form, wherein the at least one tape accelerator is selected from the group consisting of imidazoles, imidazole derivatives, pyrazoles, pyrazole derivatives and combinations thereof.

11. The insulating tape as claimed in claim 10, wherein the tape accelerator is an adduct of at least one imidazole and/or at least one pyrazole with one or more acrylates.

12. The insulating tape as claimed in claim 10, wherein the tape accelerator is an adduct of one or more imidazoles with one or more acrylates, wherein the imidazoles are selected from the group consisting of 1H-2-methylimidazole (CAS No. 693-98-1), 1H-imidazole (CAS No. 288-32-4), 1H-2-ethylimidazole (CAS No. 1072-62-4), 1H-2-propylimidazole (CAS No. 50995-95-4), 1H-2-isopropylimidazole (CAS No. 36947-68-9), 1H-2-butylimidazole (CAS No. 50790-93-7), 1H-2-isobutylimidazole (CAS No. 61491-92-7), 1H-2-tert-butylimidazole (CAS No. 36947-69-0), 1H-4-tert-butylimidazole (CAS No. 21149-98-4), 1H-4(5)-methylimidazole (CAS No. 822-36-6), 1H-2-ethyl-4-methylimidazole (CAS No. 931-36-2), 1H-4-methyl-2-phenylimidazole (CAS No. 827-43-0), 1H-4-phenylimidazole (CAS No. 670-95-1), 1H-2-phenylimidazole (CAS No. 670-96-2), and 1H-5-methyl-2-phenylimidazole-4-methanol (CAS No. 13682-32-1.

13. The insulating tape as claimed in claim 10, wherein the tape accelerator is an adduct of one or more pyrazoles with one or more acrylates, wherein the pyrazoles are selected from the group consisting of 1H-3-phenylpyrazole (CAS No. 2458 26 6), 1H-5-methylpyrazole, 1H-3,4-dimethylpyrazole (CAS No. 2820 37 3), 1H-3-tert-butylpyrazole (CAS No. 15802 80 9), 1H-4-ethylpyrazole (CAS No. 17072 38 7), 1H-pyrazole (CAS No. 288 3 1) and 1H-3,5-dimethylpyrazole (CAS No. 67 51 6).

14. The insulating tape as claimed in claim 10, wherein the tape accelerator is an adduct of one or more imidazoles and/or of one or more pyrazoles with one or more acrylates selected from the group consisting of trimethylolpropane triacrylate (TMPTA),
trimethylolpropane propoxylate triacrylate,
pentaerythritol tetraacrylate (PETA), and
dipentaerythritol pentacrylate/dipentaerythritol hexacrylate.

15. The insulating tape as claimed in claim 12, wherein the tape accelerator is an adduct of one or more imidazole derivatives with one or more acrylates selected from the group consisting of trimethylolpropane triacrylate (TMPTA); trimethylolpropane propoxylate triacrylate; pentaerythritol tetraacrylate (PETA); and dipentaerythritol pentacrylate/dipentaerythritol hexacrylate.

16. The insulating tape as claimed in claim 13, wherein the tape accelerator is an adduct of one or more pyrazole derivatives with one or more acrylates selected from the group consisting of trimethylolpropane triacrylate (TMPTA); trimethylolpropane propoxylate triacrylate; pentaerythritol tetraacrylate (PETA); and dipentaerythritol pentacrylate/dipentaerythritol hexacrylate.

17. The insulating tape as claimed in claim 10, wherein the tape accelerator is selected from the group of compounds of the structural formulae I to IV: 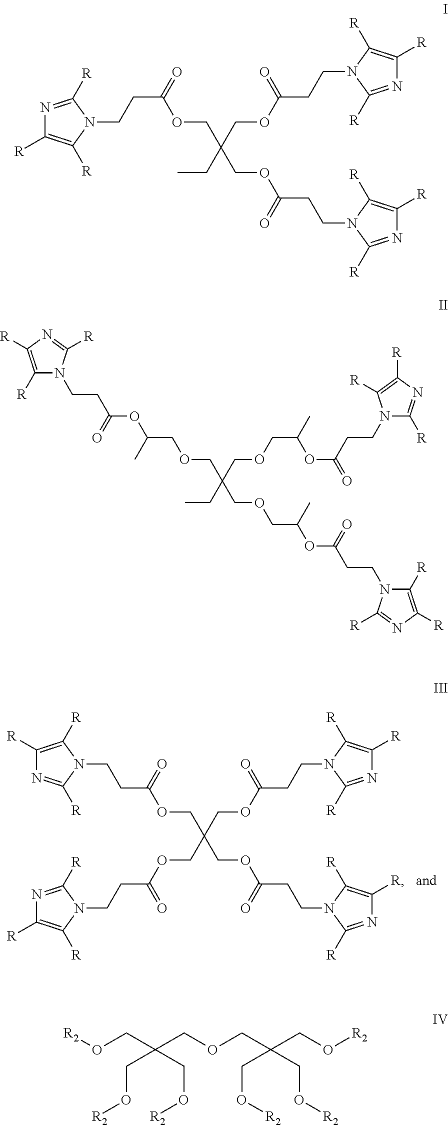
wherein R is identical or nonidentical and
R is selected from the group consisting of H, methyl, ethyl, n-propyl, isopropyl, n-butyl, isobutyl, tert-butyl, phenyl and/or mono-, di-, tri-, tetra-, and penta-substituted phenyl, wherein the substituents on the phenyl radical are identical or non-identical and are selected from the group consisting of alkyls (linear and branched), alkoxy, F, Cl, Br, I, aldehydes, ketones, acyl esters, acyl amides, phosphonic acid derivatives and sulfonic acid derivatives,
and R₂ is selected from the group consisting of H and

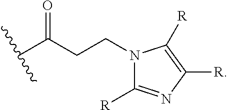

18. A coil of an electric motor/generator comprising windings, wherein at least one of the windings has an insulating tape with impregnation, wherein the insulating tape comprises at least one imidazole, at least one pyrazole, at least one imidazole derivative, or at least one pyrazole derivative as a curing agent, as a gelling agent or as a tape accelerator.

19. An electrical machine, preferably a rotating electrical machine, more preferably a rotating electrical machine in the medium-voltage and high-voltage range, and electrical switching system, medium-voltage and high-voltage application, bushing, transformer bushing, generator bushing and/or HVDC bushing, and corresponding intermediate product, comprising an insulating tape as claimed in claim 10.

20. A method for gelling or curing phthalic anhydride-free epoxy resins based on bisphenol A and/or bisphenol F diglycidyl ether, the method comprising
impregnating the resins with at least one curing or gelling agent selected from the group consisting of imidazoles, pyrazoles, imidazole derivatives, pyrazole derivatives, and combinations thereof.
